(19) United States
(12) Patent Application Publication
(10) Pub. No.: US 2005/0051699 A1
(43) Pub. Date: Mar. 10, 2005

(54) [MICROSCOPE LIGHT REGULATOR]

(76) Inventors: Bernard Petrillo, N. White Plains, NY (US); Bruno Israel, Kinderhook, NY (US)

Correspondence Address: RHODES INSTRUMENT CORPORATION, 11 VIRGINIA ROAD, N. WHITE PLAINS, NY, 10603, US

(21) Appl. No.: 10/605,101

(22) Filed: Sep. 9, 2003

(51) Int. Cl. G01J 1/32

(52) U.S. Cl. 250/205

(57) ABSTRACT

A control system has been designed that maintains the overall intensity of a microscope's viewed image at a constant level. The system is further enhanced to match the color character of the microscope illuminator to a user-established color reference for replication and comparison purposes. A comparison bridge utilizing this system is described that is fully balanced in intensity and color character.

### BACKGROUND OF INVENTION

1. Field of the Invention

The invention relates to the need to provide a constant level of illumination of the viewed image when performing analyses with a microscope. This invention can also result in the illumination characteristics at the point of viewing being intensity and color balanced with regard to a chosen reference.

2. Description of the Prior Art

Typical microscope systems employ various methods of intensity control of the illuminator. While the output intensity of the illumination source has been regulated, it does not consider any attenuation or unwanted spectral-changing effects that occur in the optical path between the illumination output and the viewed image.

Three applications exist that are enhanced when the illumination level is sampled and regulated at the point where the image is being viewed. These are (1) when the operator is optimizing viewing adjustments or when repositioning the specimen results in wide attenuation swings, (2) when real-time comparative studies are performed, and (3) when it is necessary to accurately recreate the illumination conditions associated with a former viewed image.

Normal use of a microscope requires constant changing of lenses, filters, and diaphragms to optimize the particular viewing objectives. Varying degrees of attenuation are correspondingly introduced into the illumination optical network. To compensate for these alterations in viewing intensity, the user is required to continually readjust the level of the system's illuminator. Associated with these intensity changes in incandescent illuminators are unwanted color temperature shifts in the illumination spectra.

Microscope systems that are used to study the comparative characteristics of two specimens utilize a comparison bridge to view these images. They are essentially two independent optical systems whose final images are presented to the viewer for comparative analyses.

As the output of the illuminator of each channel travels its optical path through an array of lenses, filters, and diaphragms, slight differences in the illumination intensity levels between the two channels are experienced. When it is necessary to replicate an illuminated scene that is an exact reproduction of a given value for these analyses, a stored or real-time value of that illumination spectrum must be matched. It is imperative that these two views be intensity and color balanced to allow an accurate comparison to be performed.

To minimize these imbalances, a single illuminator with a split output for each optical channel may be implemented. It remains, however, a formidable task to subsequently balance the two optical channels to insure that specimen data introduced in one channel will be identical in intensity and color with the other channel when they are compared.

### SUMMARY OF INVENTION

It is an object of this invention to provide a microscope system whose viewed image is maintained at a constant level of intensity.

It is a further object of this invention to also regulate the relative spectral quality of the illuminator(s) contribution to the viewed image.

It is another object of this invention to provide a comparison bridge for microscopes that compensates for any differences in the relative intensity and spectral quality of the dual optical channels.

These goals are achieved by monitoring the illuminator(s) output and specimen images at the end of their optical travel where the final image is formed for viewing. A sample of these outputs is detected to provide electronic error signals for a closed loop servo system that either alters the attenuation of a variable neutral density filter for intensity control and/or introduces color components to match a reference illumination spectrum.

Color compensation is attained by utilizing spectrally-matched pairs of detector/LED combinations. The LED outputs are either added or subtracted to the basic illuminator output to eliminate any relative spectral deviations.

### BRIEF DESCRIPTION OF DRAWINGS

FIG. 1 is a block diagram of the basic control loop.

FIG. 2 is a block diagram of a color-balanced illuminator.

FIG. 3 is a block diagram of a color-balanced comparison bridge.

FIG. 4 details the optical data flow through the comparison bridge output beam splitter.

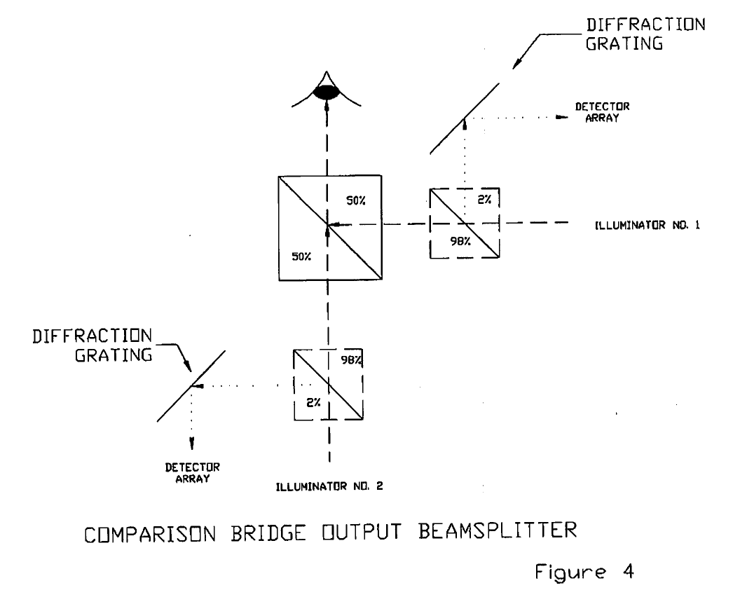

### DETAILED DESCRIPTION

The salient feature of this invention is that it monitors and controls the visual environment of the final viewed image. Three applications are presented to demonstrate the implementation of this concept.

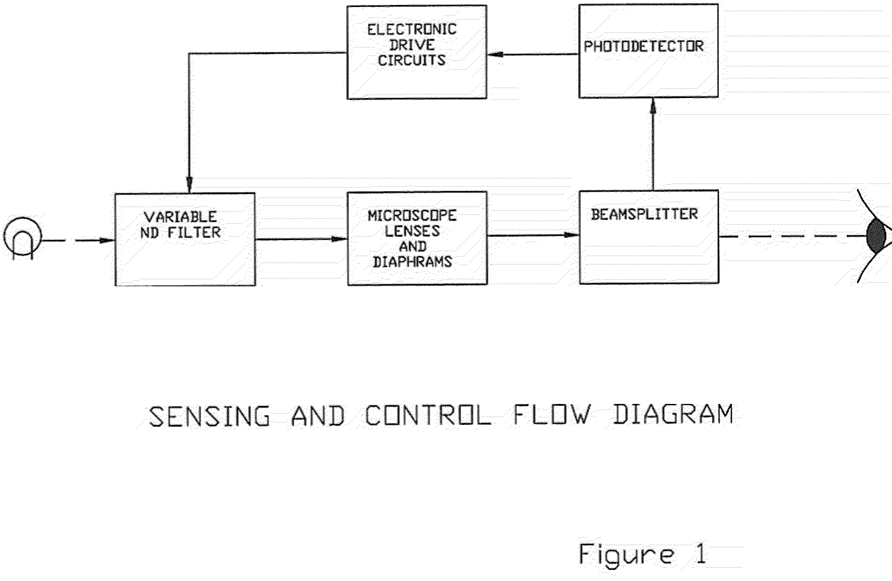

Application No. 1 (FIG. 1)

This is the most basic application. A beam splitter extracts a 2% sample of the overall viewed image and uses this data to maintain this scene constant.

FIG. 1 depicts the conventional optical path traversed by the illuminator energy and the specimen image in a typical microscope system. In addition, a feedback loop has been added that controls the attenuation of the variable density filter. The input for the feedback loop is optical data sampled via the beam splitter. This beam splitter is a thin optical cover glass that only removes about 2% of the total light energy.

Operationally, the operator sets the illuminator at its rated value and manually adjusts the variable neutral density filter while the feedback loop is disabled. Once the desired intensity level is attained, the setting is stored in the feedback circuit and the loop is activated. The beam splitter data sample is subsequently continuously compared to the stored data. Any deviation in the light sample generates a difference error signal that is nulled by electronically altering the attenuation of the variable neutral density filter.

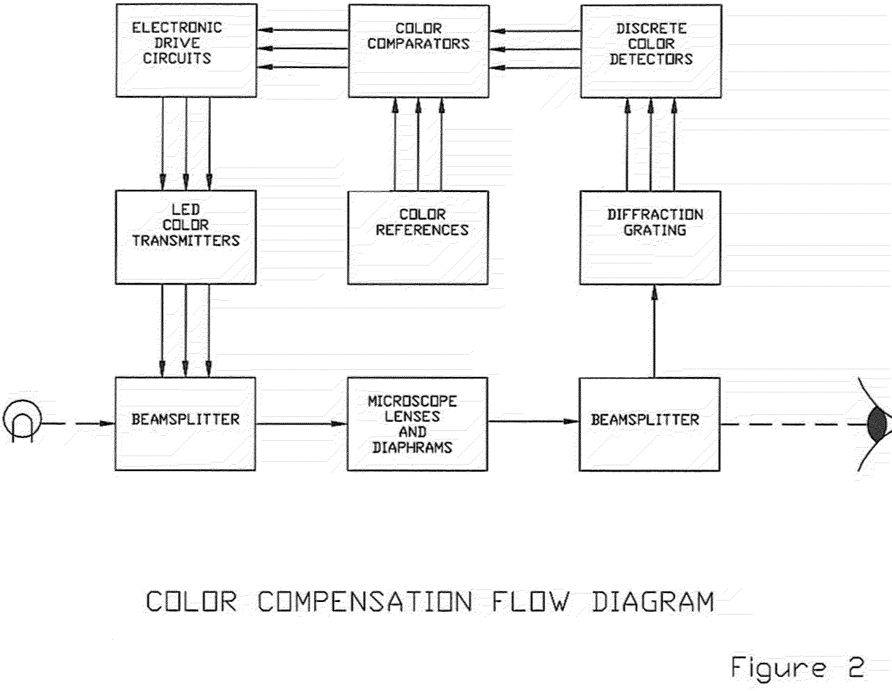

Application No. 2 (FIG. 2)

The same closed loop approach is utilized to maintain the spectral characteristic of the illuminator constant at the point of viewing.

In this application, any specimen(s) are removed from the microscope stage so that only the illuminator output is sampled by the output beam splitter. This sample illuminates a diffraction grating that spatially spreads it's color components. These components are sensed by three angularly-displaced detectors. The relative displacement of these detectors serves to selectively sense three unique colors of the illumination spectrum (e.g., red, blue, and green).

The outputs of the detectors are compared to stored references to develop three independent differential error signals. The outputs of a set of LEDs are mixed with the illuminator output. Each LED is color-matched to it's respective detector.

The outputs of the LEDs are driven to eliminate the error signal thereby matching the stored reference.

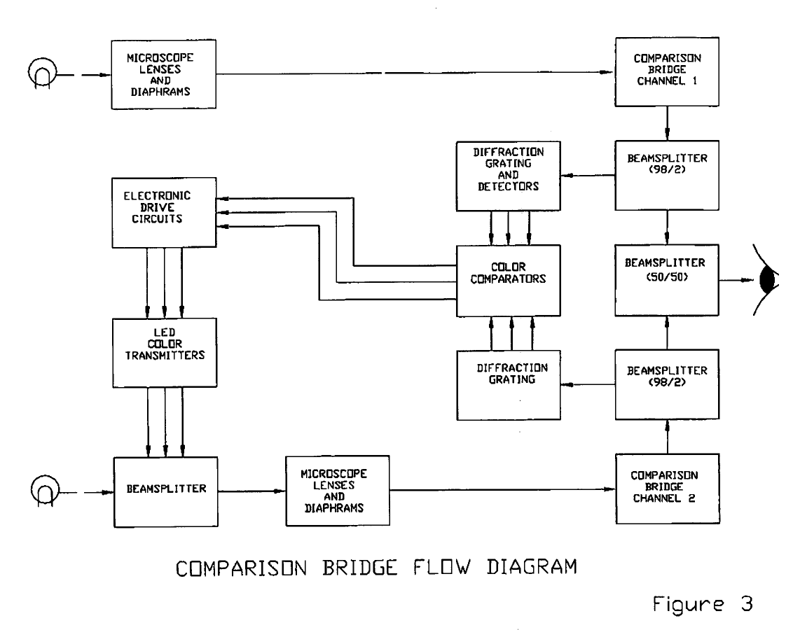

Application No. 3 (FIG. 3)

The system of Application No. 2 is extended to match the intensity and color characteristics of the dual optical channels of a comparison bridge. In place of the stored color reference, a diffraction grating is utilized to extract the reference color levels of one of the comparison bridge's illuminators. A second grating provides a similar set of color levels from the second optical channel. The illuminator output of the second channel is modified by the LED array until the combined output matches the reference channel data.

The resulting contribution of each illuminator to their respective final viewed images will be identical.

1. A control system that regulates the intensity of the final image at a constant level.

2. The control system of claim 1, further comprising:
a diffraction grating with spatially displaced color photo detectors to detect the power levels of selected color components of the illuminator output as viewed by the user.

3. The control system of claim 2, further comprising:
an array of color-radiating devices, e.g., LEDs, (Light Emitting Diodes), whose outputs are merged with the illuminator output to maintain the respective spectra of the illuminator constant as viewed by the user.

4. The control system of claim 3, further comprising:
the capability of equalizing the dual paths of a comparison bridge to eliminate any differences in color quality and intensity of the respective illuminators at the final point of viewing

5. A microscope illuminator that can radiate power at any discrete color.
